(19) United States
(12) Patent Application Publication
(10) Pub. No.: US 2018/0026266 A1
(43) Pub. Date: Jan. 25, 2018

(54) Positive Active Material For Lithium Secondary Battery, Method For Producing Same, And Lithium Secondary Battery Comprising Same

(71) Applicant: L&F CO., LTD., Daegu (KR)

(72) Inventors: Su An Choi, Chilgok-gun, Gyeongsangbuk-do (KR); Ho Jun Jeong, Chilgok-gun, Gyeongsangbuk-do (KR); Sang Hoon Jeon, Chilgok-gun, Gyeongsangbuk-do (KR); Su Youn Kwon, Chilgok-gun, Gyeongsangbuk-do (KR); Ji Sun An, Chilgok-gun, Gyeongsangbuk-do (KR); Bong Jun Jeong, Chilgok-gun, Gyeongsangbuk-do (KR)

(21) Appl. No.: 15/547,025

(22) PCT Filed: Feb. 1, 2016
(86) PCT No.: PCT/KR2016/001074

§ 371 Date: Jul. 27, 2017

(30) Foreign Application Priority Data
Jan. 30, 2015 (KR) 10-2015-0014634

(51) Int. Cl. H01M 4/525; H01M 10/052; H01M 4/505

(52) U.S. Cl. CPC H01M 4/525; H01M 4/505; H01M 10/052; H01M 2004/028

(57) ABSTRACT

Provided is a positive active material for a lithium secondary battery, which is a compound capable of reversible intercalation and deintercalation of lithium and having secondary particles formed by the aggregation of primary particles, wherein the size of crystal grains is between 0.0593 and 0.0610 μm at a (003) peak in the spectrum analysis of X-ray diffraction analysis.

### CROSS-REFERENCE TO RELATED APPLICATION(S)

This application is the U.S. National Phase application of PCT application number PCT/KR2016/001074 having a PCT filing date of Feb. 1, 2016, which claims priority of Korean patent application 10-2015-0014634 filed on Jan. 30, 2015, the disclosures of which are hereby incorporated by reference.

### BACKGROUND OF THE INVENTION

### Technical Field

A positive active material for a lithium secondary battery and a method of producing the positive active material for a lithium secondary battery are disclosed.

### Background Art

In recent times, portable electronic equipment with reduced size and weight has been increasingly used in accordance with development of electronic industries.

Batteries generate electrical power using an electrochemical reaction material for a positive electrode and a negative electrode. Lithium secondary batteries generate electrical energy due to chemical potential changes during intercalation/deintercalation of lithium ions at positive and negative electrodes.

The lithium secondary batteries include a material reversibly intercalating or deintercalating lithium ions during charge and discharge reactions as both positive and negative active materials, and are filled with an organic electrolyte or a polymer electrolyte between the positive and negative electrodes.

For the positive active material for a lithium secondary battery, composite metal compounds has been used and as examples thereof, composite metal oxides such as LiCoO₂, LiMn₂O₄, LiNiO₂, LiMnO₂, and the like are researched.

Among the positive active materials, a manganese-based positive active material such as LiMn₂O₄ and LiMnO₂ is easy to synthesize, costs less than other materials, has excellent thermal stability compared to other active materials, and is environmentally friendly. However, this manganese-based material has relatively low capacity.

LiCoO₂ has good electrical conductivity, a high cell voltage of about 3.7 V, and excellent cycle-life, stability, and discharge capacity, and thus is a presently-commercialized representative material. However, LiCoO₂ is so expensive that makes up more than 30% of the cost of a battery, and thus may reduce price competitiveness.

In addition, LiCoO₂ has the highest discharge capacity among the above positive active materials but is hard to synthesize. Furthermore, nickel therein is highly oxidized and may deteriorate the cycle-life of a battery and an electrode, and thus may have severe self-discharge and deterioration of reversibility. Further, it may be difficult to commercialize due to incomplete stability.

### DISCLOSURE

### Technical Problem

A positive active material for a lithium secondary battery having excellent cycle-life characteristics and a lithium secondary battery including the positive electrode including a positive active material are provided.

### Technical Solution

In an embodiment of the present invention, a positive active material for a lithium secondary battery is a compound capable of reversible intercalation and deintercalation of lithium, whose primary particles are aggregated into a secondary particle, and

has a size of crystal grains in a range of 0.0593 and 0.0610 μm at a (003) peak in the analysis of X-ray diffraction spectrum analysis.

The compound having the secondary particles formed by the aggregation of primary particles may be a nickel composite oxide.

The compound being capable of intercalating and deintercallating lithium may be positive active material for a lithium secondary battery represented by Chemical Formula 1.

Li[Li_{z}A_{(1-z-a)}Dₐ]E_{b}O_{2-b} Chemical Formula 1

In Chemical Formula 1, A=NiαCoβMnγ, D is one or more element selected from the group consisting of Mg, Al, B, Zr, and Ti, E is one or more element selected from the group consisting of P, F, and S, −0.05≦z≦0.1, 0≦a≦0.05, 0≦b≦0.05, 0.6≦α≦0.81, 0.10≦β≦0.20, and 0.10≦γ≦0.20.

The compound may have a strain % of 8 to 20% in the spectrum analysis of X-ray diffraction analysis.

The compound may be LiNi_{0.80}Co_{0.10}Mn_{0.10}O₂ as a nickel composite oxide.

The compound may be LiNi_{0.70}Co_{0.15}Mn_{0.15}O₂ as a nickel composite oxide.

In another embodiment of the present invention, a method of producing a positive active material for a lithium secondary battery includes

preparing a nickel composite hydroxide; and a lithium supplying material to prepare a mixture; and

heat-treating the prepared mixture under an oxygen and/or air atmosphere to obtain a compound of Chemical Formula 1:

Li[Li_{z}A_{(1-z-a)}Dₐ]E_{b}O_{2-b} Chemical Formula 1

In Chemical Formula 1, A=NiαCoβMnγ, D is one or more element selected from the group consisting of Mg, Al, B, Zr, and Ti, E is one or more element selected from the group consisting of P, F, and S, −0.05≦z≦0.1, 0≦a≦0.05, 0≦b≦0.05, 0.6≦α≦0.81, 0.10≦β≦0.20, and 0.10≦γ≦0.20.

In the step of heat-treating the mixture under the oxygen and/or air atmosphere to obtain the compound of Chemical Formula 1;

a method of producing a positive active material for a lithium secondary battery wherein the heat-treating temperature may be 700 to 950° C.

Li[Li_{z}A_{(1-z-a)}Dₐ]E_{b}O_{2-b} Chemical Formula 1

In Chemical Formula 1, A=NiαCoβMnγ, D is one or more element selected from the group consisting of Mg, Al, B, Zr, and Ti, E is one or more element selected from the group consisting of P, F, and S, −0.05≦z≦0.1, 0≦a≦0.05, 0≦b≦0.05, 0.6≦α≦0.81, 0.10≦β≦0.20, and 0.10≦γ≦0.20.

In the heat-treating under the oxygen and/or air atmosphere, a ratio of oxygen and air in a first temperature section and a second temperature section of a temperature-increasing section may be 25:75 to 35:65.

In the heat-treating under the oxygen and/or air atmosphere, a ratio of oxygen and air in a first temperature section and a second temperature section of a temperature-increasing section may be 25:75 to 35:65,

a third temperature section and a fourth temperature section of the temperature-increasing section may be under an oxygen atmosphere, and

a ratio of oxygen and air of a temperature maintenance section of the heat-treating may be 25:75 to 35:65.

In the entire section in the heat-treating under the oxygen and/or air atmosphere, a ratio of oxygen and air may be 65:35 to 75:25.

In yet another embodiment of the present invention, a lithium secondary battery includes a positive electrode including a positive active material for lithium secondary battery according to an embodiment of the present invention; a negative electrode including a negative active material; and an electrolyte.

### Advantageous Effects

A positive active material having excellent battery characteristics and a lithium secondary battery including the same may be provided.

### BRIEF DESCRIPTION OF THE DRAWINGS

FIG. 1 is a schematic view of a lithium secondary battery.

### DETAILED DESCRIPTION

### Mode for Invention

Hereinafter, embodiments of the present invention are described in detail. However, these embodiments are exemplary, the present invention is not limited thereto and the present invention is defined by the scope of claims.

In an embodiment of the present invention, a positive active material for a lithium secondary battery includes a compound capable of reversible intercalation and deintercalation of lithium,

which is a compound capable of reversible intercalation and deintercalation of lithium

the size of crystal grains is between 0.0593 and 0.0610 μm at a (003) peak in the spectrum analysis of X-ray diffraction analysis.

The compound having the secondary particles formed by the aggregation of primary particles may be a nickel composite oxide.

The compound being capable of intercalating and deintercallating lithium may be positive active material for a lithium secondary battery represented by Chemical Formula 1.

Li[Li_{z}A_{(1-z-a)}Dₐ]E_{b}O_{2-b} Chemical Formula 1

In Chemical Formula 1, A=NiαCoβMnγ, D is one or more element selected from the group consisting of Mg, Al, B, Zr, and Ti, E is one or more element selected from the group consisting of P, F, and S, −0.05≦z≦0.1, 0≦a≦0.05, 0≦b≦0.05, 0.6≦α≦0.81, 0.10≦β≦0.20, and 0.10≦γ≦0.20.

The compound may have a strain % of 8 to 20% in the spectrum analysis of X-ray diffraction analysis.

The compound may be LiNi_{0.80}Co_{0.10}Mn_{0.10}O₂ as a nickel composite oxide.

The compound may be LiNi_{0.70}Co_{0.15}Mn_{0.15}O₂ as a nickel composite oxide.

In the spectrum analysis of X-ray diffraction analysis, a (003) peak indicates a development of a layered structure. An active material surface structure is improved due to development of the layered structure, and boundary numbers between primary particles are decreased due to increase of a crystallite size, and thus Li may be more easily transported and battery characteristics are improved.

In addition, in the spectrum analysis of X-ray diffraction analysis, strain % is decreased and thus a stress in a structure is decreased to contribute a structure stabilization.

In another embodiment of the present invention, a method of producing a positive active material for a lithium secondary battery includes

preparing a nickel composite hydroxide; and a lithium supplying material to prepare a mixture; and

heat-treating the prepared mixture under an oxygen and/or air atmosphere to obtain a compound of Chemical Formula 1:

Li[Li_{z}A_{(1-z-a)}Dₐ]E_{b}O_{2-b} Chemical Formula 1

In Chemical Formula 1, A=NiαCoβMnγ, D is one or more element selected from the group consisting of Mg, Al, B, Zr, and Ti, E is one or more element selected from the group consisting of P, F, and S, −0.05≦z≦0.1, 0≦a≦0.05, 0≦b≦0.05, 0.6≦α≦0.81, 0.10≦β≦0.20, and 0.10≦γ≦0.20.

In the step of heat-treating the mixture under the oxygen and/or air atmosphere to obtain the compound of Chemical Formula 1;

a method of producing a positive active material for a lithium secondary battery wherein the heat-treating temperature may be 700 to 950° C.

Li[Li_{z}A_{(1-z-a)}Dₐ]E_{b}O_{2-b} Chemical Formula 1

In Chemical Formula 1, A=NiαCoβMnγ, D is one or more element selected from the group consisting of Mg, Al, B, Zr, and Ti, E is one or more element selected from the group consisting of P, F, and S, −0.05≦z≦0.1, 0≦a≦0.05, 0≦b≦0.05, 0.6≦α≦0.81, 0.10≦β≦0.20, and 0.10≦γ≦0.20.

In the heat-treating under the oxygen and/or air atmosphere temperature-increasing section, a ratio of oxygen and air may be 25:75 to 35:65.

In the heat-treating under the oxygen and/or air atmosphere, a ratio of oxygen and air in a first temperature section and a second temperature section of a temperature-increasing section may be 25:75 to 35:65,

a third temperature section and a fourth temperature section of the temperature-increasing section may be under an oxygen atmosphere, and

a ratio of oxygen and air of a temperature maintenance section of the heat-treating may be 25:75 to 35:65.

In the entire section in the heat-treating under the oxygen and/or air atmosphere, a ratio of oxygen and air may be in a range of 65:35 to 75:25.

Battery characteristics may be improved by including an air atmosphere through the above atmosphere adjustment unlike a heat treatment under an oxygen atmosphere over the entire section to input CO₂ into the Li reaction section and thus to develop a layered structure and thus improving the surface structure of an active material.

In addition, oxygen may be used in a less amount, and thus processibility may be improved.

The other components are the same as those of the above embodiment of the present invention and thus will not be reillustrated.

In yet another embodiment of the present invention, a lithium secondary battery includes a positive electrode, a negative electrode, and an electrolyte, wherein the positive electrode includes a current collector and a positive active material layer formed on the current collector and the positive active material layer includes the positive active material.

The positive active material is the same as the above-described embodiment of the present invention and its description is not additionally provided.

The positive active material layer includes a binder and a conductive material.

The binder improves binding properties of positive active material particles with one another and with a current collector, and examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves electrical conductivity of a negative electrode. Any electrically conductive material can be used as a conductive agent unless it causes a chemical change, and examples of the conductive material include a carbon-based material such as natural graphite, artificial graphite, carbon black, acetylene black, ketjen black, and carbon fiber, a metal-based material such as a metal powder or a metal fiber of copper, nickel, aluminum, silver, and the like, and a conductive polymer such as a polyphenylene derivative, or a mixture thereof.

The negative electrode includes a current collector and a negative active material layer formed on the current collector, and the negative active material layer includes a negative active material.

The negative active material includes a material that reversibly intercalates/deintercalates lithium ions, a lithium metal, a lithium metal alloy, a material being capable of doping and dedoping lithium, or a transition metal oxide.

The material that can reversibly intercalate/deintercalate lithium ions includes a carbon material. The carbon material may be any generally-used carbon-based negative active material in a lithium ion rechargeable battery. Examples of the carbon material include crystalline carbon, amorphous carbon, and mixtures thereof. The crystalline carbon may be non-shaped, or sheet, flake, spherical, or fiber shaped natural graphite or artificial graphite. The amorphous carbon may be a soft carbon (low temperature fired carbon), a hard carbon, a mesophase pitch carbonized product, fired coke, and the like.

The lithium metal alloy include lithium and a metal selected from the group consisting of the group consisting of Na, K, Rb, Cs, Fr, Be, Mg, Ca, Sr, Si, Sb, Pb, In, Zn, Ba, Ra, Ge, Al, and Sn.

The material being capable of doping and dedoping lithium may include Si, SiOx (0<x<2), a Si—Y alloy (wherein Y is an element selected from the group consisting of an alkali metal, an alkaline-earth metal, a Group 13 element, a Group 14 element, a transition metal, a rare earth element, and a combination thereof, and is not Si), Sn, SnO₂, or Sn—Y (wherein Y is an element selected from the group consisting of an alkali metal, an alkaline-earth metal, a Group 13 element, a Group 14 element, a transition metal, a rare earth element, and a combination thereof, and is not Sn). At least one of these materials may be mixed with SiO₂. The element Y may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

The transition metal oxide may include vanadium oxide, lithium vanadium oxide, and the like.

The negative active material layer may include a binder, and optionally a conductive material.

The binder improves binding properties of negative active material particles with one another and with a current collector, and examples thereof may be polyvinyl alcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves electrical conductivity of a negative electrode and any electrically conductive material may be used as a conductive agent unless it causes a chemical change, and examples of the conductive material include a carbon-based material such as natural graphite, artificial graphite, carbon black, acetylene black, ketjen black, and carbon fiber; a metal-based material such as a metal powder or a metal fiber of copper, nickel, aluminum, silver, and the like; and a conductive polymer such as a polyphenylene derivative; or a mixture thereof.

The current collector may be selected from the group consisting of a copper foil, a nickel foil, a stainless steel foil, a titanium foil, a nickel foam, a copper foam, a conductive polymer substrate coated with a metal, and a combination thereof.

The current collector may be Al, but is not limited thereto.

The negative electrode and the positive electrode may be manufactured by a method including mixing each active material, a conductive material, and a binder into an active material composition and coating the composition on a current collector. The electrode manufacturing method is well known, and thus is not described in detail in the present specification. The solvent includes N-methylpyrrolidone and the like, but is not limited thereto.

The electrolyte includes a non-aqueous organic solvent and a lithium salt.

The non-aqueous organic solvent serves as a medium for transmitting ions taking part in the electrochemical reaction of a battery.

The organic solvent may further include one selected from an ester-based, ether-based, ketone-based, or alcohol-based solvent, and an aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like, and the ester-based solvent may include methyl acetate, ethyl acetate, n-propyl acetate, dimethylacetate, methylpropionate, ethylpropionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, and the like, and the ketone-based solvent may include cyclohexanone, and the like. The alcohol-based solvent include ethyl alcohol, isopropyl alcohol, and the like, and examples of the aprotic solvent include nitriles such as R—CN (where R is a C2 to C20 linear, branched, or cyclic hydrocarbon, a double bond, an aromatic ring, or an ether bond), amides such as dimethylformamide, dioxolanes such as 1,3-dioxolane, sulfolanes, and the like.

The non-aqueous organic solvent may be used alone or in a mixture, and when the organic solvent is used in a mixture, the mixture ratio may be controlled in accordance with a desirable battery performance.

The carbonate-based solvent is prepared by mixing a cyclic carbonate and a linear carbonate. In this case, the cyclic carbonate and linear carbonate are mixed together in a volume ratio of 1:1 to 1:9, which may have enhanced performance.

The non-aqueous organic solvent according to an embodiment of the present invention may further include an aromatic hydrocarbon-based organic solvent in addition to the carbonate based solvent. The carbonate-based solvent and aromatic hydrocarbon-based solvent may be mixed together in a volume ratio of 1:1 to 30:1.

The aromatic hydrocarbon-based organic solvent may be an aromatic hydrocarbon-based compound represented by Chemical Formula 2.

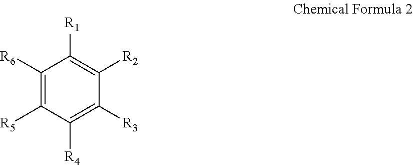

(wherein, in Chemical Formula 2, R₁ to R₆ are independently hydrogen, halogen, a C1 to C10 alkyl group, a haloalkyl group, or a combination thereof)

The aromatic hydrocarbon-based organic solvent may be selected from the group consisting of benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and a combination thereof.

The non-aqueous electrolyte may further include vinylene carbonate or an ethylene carbonate-based compound represented by Chemical Formula 3 to improve a cycle life.

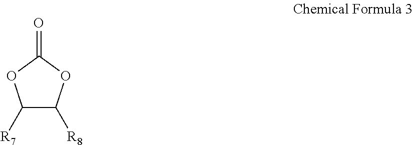

(wherein, in Chemical Formula 3, R₇ and R₈ are independently hydrogen, a halogen, a cyano group (CN), a nitro group (NO2), or a C1 to C5 fluoroalkyl group, provided that at least one of R₇ and R₈ is a halogen, a cyano group (CN), a nitro group (NO₂), or a C1 to C5 fluoroalkyl group)

Examples of the ethylene carbonate-based compound include difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle life may be desirably used within an appropriate range.

The lithium salt dissolved in an organic solvent supplies a battery with lithium ions, basically operates the lithium secondary battery, and improves transportation of the lithium ions between positive and negative electrodes. Examples of the lithium salt include one or more supporting salt selected from LiPF₆, LiBF₄, LiSbF₆, LiAsF₆, LiC₄F₉SO₃, LiClO₄, LiAlO₂, LiAlCl₄, LiN(CₓF₂ₓ+₁SO₂)(C_{y}F_{2y+1}SO₂), wherein, x and y are natural numbers, LiCl, LiI and LiB(C₂O₄)₂ (lithium bis(oxalato) borate; LiBOB). A concentration of the lithium salt may range from about 0.1 M to about 2.0 M. When the lithium salt is included at the above concentration range, an electrolyte may have excellent performance and lithium ion mobility due to optimal electrolyte conductivity and viscosity.

The lithium secondary battery may further include a separator between a negative electrode and a positive electrode. The separator includes polyethylene, polypropylene, or polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The lithium secondary battery may be classified into a lithium ion battery, a lithium ion polymer battery, and a lithium polymer battery depending on kinds of a separator and an electrolyte. It also may be classified to be cylindrical, prismatic, coin-type, pouch-type, and the like depending on its shape. In addition, it may be a bulk type and a thin film type depending on size. Structures and manufacturing methods for lithium ion batteries pertaining to this disclosure are well known in the art.

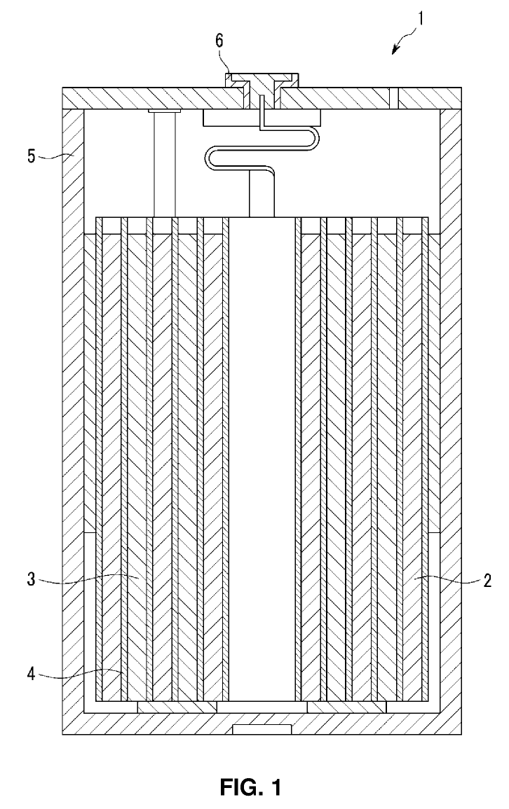

FIG. 1 shows a representative structure of a lithium secondary battery of the present invention. As shown in FIG. 1, the lithium secondary battery 1 includes a battery case 5 including an electrolyte solution impregnated in a positive electrode 3, a negative electrode 2, and a separator 4 between the positive electrode 3 and the negative electrode 2, and a sealing member 6 sealing the battery case 5.

Hereinafter, examples of the present invention and comparative examples are described. These examples, however, are not in any sense to be interpreted as limiting the scope of the invention.

### EXAMPLE

### Example 1

LiOH and Ni_{0.80}Co_{0.10}Mn_{0.10}(OH)₂ were mixed in a weight ratio of 1:1.02 (metal:Li) by using a mixer. The obtained mixture was fired for 13 hours in total under an atmosphere of oxygen and air in a ratio of 70:30 to obtain a fired product by increasing a temperature for 6 hours and maintaining the temperature at 750° C. for 7 hours.

The fired product was slowly cooled down and pulverized to obtain a positive active material.

### Example 2

LiOH and Ni_{0.80}Co_{0.10}Mn_{0.10}(OH)₂ were mixed in a weight ratio of 1:1.02 (metal:Li) with a mixer. The obtained mixture was fired for 13 hours in total to obtain a fired product by increasing a temperature for 6 hours and maintaining the temperature at 750° C. for 7 hours by increasing a temperature under an atmosphere of oxygen and air in a ratio of 30:70 in a first temperature section and a second temperature section and maintaining the temperature at 750° C. for 7 hours under an oxygen atmosphere in a third temperature section and a fourth temperature section.

The fired product was slowly cooled down and pulverized to prepare a positive active material.

### Comparative Example 1

LiOH and Ni_{0.80}Co_{0.10}Mn_{0.10}(OH)₂ were mixed in a weight ratio of 1:1.02 (metal:Li). The obtained mixture was fired for 13 hours in total under an oxygen atmosphere to obtain a fired product by increasing a temperature for 6 hours and maintaining the temperature at 750° C. for 7 hours.

The fired product was slowly cooled down and pulverized to prepare a positive active material.

Manufacture of Coin Cell

95 wt % of each positive active material prepared in Examples and Comparative Example, 2.5 wt % of carbon black as a conductive agent, and 2.5 wt % of PVDF as a binder were added to 5.0 wt % of N-methyl-2 pyrrolidone (NMP) as a solvent to prepare positive electrode slurry. The positive electrode slurry was coated to be 20 to 40 μm thick on an aluminum (Al) thin film as a positive electrode current collector, vacuum-dried, and roll-pressed, manufacturing a positive electrode.

As for a negative electrode, a Li-metal was used.

The positive electrode, the Li-metal as a counter electrode, and a 1.15 M LiPF6 EC:DMC (1:1 vol %) as an electrolyte solution were used to manufacture a coin cell type half-cell.

Initial formation charge and discharge were performed in a range of 4.3 to 3.0 V.

Charge and discharge of cycle-life characteristics were performed in a range of 4.5 to 3.0 V.

### Experimental Example 1: Evaluation of Battery Characteristics

Table 1 shows initial formation at 4.3 V, discharge capacity at each 1st cycle, 20th cycle, and 30th cycle at 4.5 V, and 45° C., and cycle-life characteristic data of Examples and Comparative Example.

TABLE 1

| | Discharge | | 1 CY | 20 CY | 30 CY | Cycle-life | Cycle-life |
|---|---|---|---|---|---|---|---|
| | capacity | | discharge | discharge | discharge | (20 CY/ | (30 CY/ |
| | (mAh/g) | Efficiency | capacity | capacity | capacity | 1CY, %) | 1CY, %) |
| Example 1 | 203.75 | 89.25 | 217.69 | 193.35 | 176.09 | 88.82 | 80.89 |
| Example 2 | 203.66 | 89.64 | 216.78 | 190.22 | 172.32 | 87.75 | 79.49 |
| Comparative | 202.64 | 89.12 | 217.75 | 190.10 | 164.31 | 87.30 | 75.46 |
| Example 1 | | | | | | | |

Referring to Table 1, Examples 1 to 2 showed excellent cycle-life characteristics compared with Comparative Example 1. The battery characteristics is improved, because the surface structure of an active material is improved due to development of a layered structure, and the number of boundary among primary particles is decreased due to an increased crystallite size.

### Experimental Example 2: XRD Measurement

Table 2 shows the X-ray diffraction (XRD) spectrum analysis data of Examples and Comparative Example. The XRD data were obtained in an X-ray diffraction method (Ultima 1V, Rigaku Corp.) under a condition of room temperature of 25° C., CuKα, a voltage of 40 kV, a current of 3 mA, 10 to 90 deg, a step width of 0.01 deg, and a step scan.

TABLE 2

| | Strain % | Crystallite size (μm) |
|---|---|---|
| Example 1 | 0.009 | 0.0609 |
| Example 2 | 0.011 | 0.0609 |
| Comparative Example 1 | 0.021 | 0.0570 |

Referring to Table 2, Examples 1 to 2 turned out to have a larger crystallite size than Comparative Example 1. The battery characteristics may be improved, because the surface structure of an active material is improved due to development of a layered structure, and Li is more easily moved due to an increased crystallite size and thus the decreased number of boundary among primary particles. In addition, a decreased strain % in the X-ray diffraction spectrum analysis shows stress decreases in the structure, which contributes to structural stability.

The present invention is not limited to the exemplary embodiment and may be embodied in various modifications, and it will be understood by a person of ordinary skill in the art to which the present invention pertains that the present invention may be carried out through other specific embodiments without modifying the technical idea or essential characteristics thereof. Therefore, the aforementioned embodiments should be understood to be exemplary but not limiting the present invention in any way.

1. A positive active material for a lithium secondary battery, comprising
a compound capable of reversible intercalation and deintercalation of lithium, wherein primary particles are aggregated into secondary particles, and
the size of crystal grains is between 0.0593 and 0.0610 μm at a (003) peak in the spectrum analysis of X-ray diffraction analysis.

2. The positive active material for a lithium secondary battery of claim 1, wherein the compound having the secondary particles formed by the aggregation of primary particles is a nickel composite oxide.

3. The positive active material for a lithium secondary battery of claim 1, wherein the compound being capable of intercalating and deintercallating lithium is represented by Chemical Formula 1, Li[Li_{z}A_{(1-z-a)}Dₐ]E_{b}O_{2-b}
(wherein, in Chemical Formula 1, A=NiαCoβMnγ, D is one or more element selected from the group consisting of Mg, Al, B, Zr, and Ti, E is one or more element selected from the group consisting of P, F, and S, −0.05≦z≦0.1, 0≦a≦0.05, 0≦b≦0.05, 0.6≦α≦0.81, 0.10≦β≦0.20, and 0.10≦γ≦0.20).

4. The positive active material for a lithium secondary battery of claim 1, wherein the compound has a strain % of 8 to 20% in the spectrum analysis of X-ray diffraction analysis.

5. The positive active material for a lithium secondary battery of claim 1, wherein the compound is LiNi_{0.80}Co_{0.10}Mn_{0.10}O₂ as a nickel composite oxide.

6. The positive active material for a lithium secondary battery of claim 1, wherein the compound is LiNi_{0.70}Co_{0.15}Mn_{0.15}O₂ as a nickel composite oxide.

7. A method of producing a positive active material for a lithium secondary battery, comprising
preparing a nickel composite hydroxide; and a lithium supplying material to prepare a mixture; and
heat-treating the prepared mixture under an oxygen and/or air atmosphere to obtain a compound of Chemical Formula 1, Li[Li_{z}A_{(1-z-a)}Dₐ]E_{b}O_{2-b}
(wherein, in Chemical Formula 1, A=NiαCoβMnγ, D is one or more element selected from the group consisting of Mg, Al, B, Zr, and Ti, E is one or more element selected from the group consisting of P, F, and S, −0.05≦z≦0.1, 0≦a≦0.05, 0≦b≦0.05, 0.6≦α≦0.81, 0.10≦β≦0.20, and 0.10≦γ≦0.20).

8. The method of producing a positive active material for a lithium secondary battery of claim 7, wherein in the step of heat-treating the mixture under the oxygen and/or air atmosphere to obtain the compound of Chemical Formula 1, Li[Li_{z}A_{(1-z-a)}Dₐ]E_{b}O_{2-b}
the heat-treating temperature is 700 to 950° C.
(wherein, in Chemical Formula 1, A=NiαCoβMnγ, D is one or more element selected from the group consisting of Mg, Al, B, Zr, and Ti, E is one or more element selected from the group consisting of P, F, and S, −0.05≦z≦0.1, 0≦a≦0.05, 0≦b≦0.05, 0.6≦α≦0.81, 0.10≦β≦0.20, and 0.10≦γ≦0.20).

9. The method of producing a positive active material for a lithium secondary battery of claim 7, wherein in the heat-treating under the oxygen and/or air atmosphere, a ratio of oxygen and air in a first temperature section and a second temperature section of a temperature-increasing section is 25:75 to 35:65.

10. The method of producing a positive active material for a lithium secondary battery of claim 7, wherein in the heat-treating under the oxygen and/or air atmosphere, a ratio of oxygen and air in a first temperature section and a second temperature section of a temperature-increasing section is 25:75 to 35:65,
a third temperature section and a fourth temperature section of the temperature-increasing section is under an oxygen atmosphere, and
a ratio of oxygen and air of a temperature maintenance section of the heat-treating is 25:75 to 35:65.

11. The method of producing a positive active material for a lithium secondary battery of claim 7, wherein in the entire section in the heat-treating under the oxygen and/or air atmosphere, a ratio of oxygen and air is 65:35 to 75:25.

12. A lithium secondary battery, comprising
a positive electrode for lithium secondary battery including a positive active material of claim 1;
a negative electrode including a negative active material; and
an electrolyte.
